(19) United States
(12) Patent Application Publication
(10) Pub. No.: US 2005/0137092 A1
(43) Pub. Date: Jun. 23, 2005

(54) Superconductive contacts with hydroxide-catalyzed bonds that retain superconductivity and provide mechanical fastening strength

(76) Inventors: John Mester, Menlo Park, CA (US); Dz-Hung Gwo, Fremont, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/850,857

(22) Filed: May 21, 2004

Related U.S. Application Data
(60) Provisional application No. 60/473,234, filed on May 23, 2003.

(51) Int. Cl. H01B 1/00

(52) U.S. Cl. 505/100

(57) ABSTRACT

A superconductive contact or contact structure composed mainly of superconductors and a hydroxide-catalyzed bond that establishes electrical contacts, retains superconductivity, and provides the full mechanical fastening strength between the superconductors. According to the present invention, the superconductive contact structure exhibits a single-film superconductive behavior. In some embodiments, the structure has a configuration of two metallic low critical-temperature (low-T_{c}) superconductors, such as niobium (Nb), connectorized by an essentially transparent and extremely thin hydroxide-catalyzed bond. In some embodiments, two ceramic high critical-temperature (high-T_{c}) superconductors, such as perovskite ceramics (e.g., YBa₂Cu₃O₇ or YBCO in general) are joined via a hydroxide-catalyzed bond. In some embodiments, a metallic low-T_{c} superconductor and a ceramic high-T_{c} superconductor is connectorized via a hydroxide-catalyzed bond.

### CROSS REFERENCE TO RELATED APPLICATIONS

This application claims priority from and incorporates by reference the content of a provisional patent application No. 60/473,234, filed May 23, 2003. This application relates to U.S. patent application Ser. No. 09/325,995, filed Jun. 4, 1999, U.S. Pat. No. 6,548,176, which is a continuation-in-part of U.S. patent application Ser. No. 09/054,970, filed Apr. 4, 1998, U.S. Pat. No. 6,284,085, which claims priority from provisional patent application Ser. No. 60/042,616, filed Apr. 3, 1997, and 60/043,514, filed Apr. 14, 1997, all of which are hereby incorporated by reference.

### STATEMENT REGARDING FEDERALLY SPONSORED RESEARCH OR DEVELOPMENT

This invention was supported in part by NASA Grant No. NAS 8-39225. The U.S. Government may have certain rights in this invention.

### FIELD OF THE INVENTION

The invention generally relates to superconductors and, more particularly, to a superconductive contact or contact structure having high- and/or low-critical-temperature superconductors with a hydroxide-catalyzed bond that establishes electrical contacts, retains superconductivity, and provides the full mechanical fastening strength thereof.

### DESCRIPTION OF THE BACKGROUND ART

High-critical-temperature (high-T_{c}) superconductors play critical roles in developing superconductor commercial applications/products related to
electric-power generation and transmission,
energy storage,
marine-vehicle propulsion,
telecommunication,
magnetic-field detection,
medical imaging, etc.

Consequently, high-T_{c} superconductive connections/contacts/bonds/junctions/interfaces capable of high-critical current densities are extremely desirable. Unfortunately, this goal is difficult to achieve in today's superconductor industry.

As pointed out in U.S. Pat. No. 6,258,754, issued to Sengupta and entitled, “LARGE, STRONGLY LINKED SUPERCONDUCTING MONOLITHS AND PROCESS FOR MAKING THE SAME”, one of the major problems inhibiting widespread application of high temperature superconductors is their poor current-carrying capability (critical current density, “J_{c}”). As a result of deterioration in crystal perfection, the rate of increase in the trapped field of a superconductor sample decreases drastically when the sample size is large, i.e., roughly 50 mm or more. Sengupta discloses a top-seeded, melt processing technique that can produce large single-domain high temperature superconductors with current-carrying capability above 10,000 A/cm² at 77° K. More specifically, two single domain structurally equivalent superconductors having a first melting point are previously grown using a seeded melt-textured growth. A bonding material of ytterbium or yttrium-based powder having a second melting point lower than the first melting point is applied to the ac plane of the two individual superconductors. The assembly so formed is then heat-treated to melt the bonding material and cooled slowly to allow the bond to grow epitaxially on the interface. The final assembly has a diameter of 50 mm or more. The thickness of the bond was not disclosed.

Clearly, there are continuing needs in the art for superconductive contacts that connectorize low-T_{c} superconductors, high-T_{c} superconductors, and a combination thereof, that retains superconductivity across the bonding interface, that provides full mechanical fastening strength, and that is suitable for microfabrication. The present invention addresses these needs.

### SUMMARY OF THE INVENTION

The present invention provides superconductive contacts or contact structures made of high- and/or low-critical-temperature superconductors connectorized, joined, interfaced, adhered, attached, or otherwise bonded by a hydroxide-catalyzed bond that establishes electrical contacts, retains superconductivity, provides the full mechanical fastening strength between the superconductors, and is particularly useful in microfabrication. Within the context of the present application, the terms, “connection”, “connectorization”, “contact”, “bond”, “interface”, and “junction”, are used interchangeably to characterize the relationship between individual superconductors. Superconductivity is commonly defined as the ability of some metals, alloys, and ceramics to conduct electric current with negligible internal resistance at temperatures near absolute zero and, in some cases, at higher temperatures.

The hydroxide-catalyzed bond enables the retention of superconductivity across the contacting/bonding interface directly between superconductors, between low-T_{c} superconductors, between high-T_{c} superconductors, and between a low-T_{c} superconductor and a high-T_{c} superconductor.

In addition to retaining superconductivity, the hydroxide-catalyzed bond brings together superconductors with full mechanical fastening strength. As one skilled in the art can readily appreciate, an advantage over existing conductive contacts is that the superconductive connections or contacts disclosed herein can be conveniently made without relying on spot welding or soldering, which creates only normal-conductive or non-superconducting connections or ohmic contacts.

In the present superconductor industry, spot-welding and/or soldering is commonly applied between metallic low-T_{c} superconductors or between the metallic substrates that support ceramic high-T_{c} superconductors. Most low-T_{c} superconductors are metallic, and thus may rely on spot welding or soldering for connectorization. However, most high-T_{c} superconductors are non-metallic and cannot be spot-welded or soldered. Currently, the industry possesses no technology in making truly superconducting interface between superconductors, neither low-T_{c} nor high-T_{c}. The present invention may therefore serves as a fundamental enabling technology that provides for superconductive interfaces or contacts with certain superconductive electronic/electrical properties, which are of technical importance but cannot be created otherwise, for instance, connectorizing most low-T_{c} superconductors, most high-T_{c} superconductors, as well as combinations thereof.

One skilled in the art will appreciate that it is within the scope of the present invention to directly interface a low-T_{c} superconductor with a normal conductor, such as a metal; a high-T_{c} superconductor with a normal conductor, such as a metal; a low-T_{c} superconductor with an insulator; and a high-T_{c} superconductor with an insulator.

According to an aspect of the present invention, devices created with the contacting/bonding mechanisms disclosed herein help to create electron quantum-tunneling effects, e.g., the effect associated with the known Josephson junction. These advantages are further described herein in a later section. For a case study of the Josephson effect, readers are directed to an exemplary article by Gennady A. Ovsyannikov et al., entitled “Josephson Effect in Nb/Au/YBCO Heterojunctions”, IEEE Transactions on Applied Superconductivity, Vol. 13, No. 2, June 2003, pp. 881-884.

According to another aspect of the present invention, superconductive contacts can have the following configurations:
between superconductor thin films, which may or may not be substrate-supported;
between non-thin-film superconductors; and
between a non-thin-film superconductor and a superconductor thin film, which may or may not be substrate-supported.

Still further objects and advantages of the present invention will become apparent to one of ordinary skill in the art upon reading and understanding the drawings and detailed description disclosed herein. The drawings disclosed herein are for purposes of illustrating the embodiment(s) of the present invention and are not to be construed as limiting the present invention. As it will be appreciated by one of ordinary skill in the art, various changes, substitutions, modifications, and alternations can be made and/or implemented without departing from the principles and the scope of the present invention.

### BRIEF DESCRIPTION OF THE DRAWINGS

FIG. 1A shows two substrate-supported thin-film superconductors forming a superconductive contact or contact structure with a hydroxide-catalyzed bond.

FIG. 1B shows a superconductive contact or structure composed mainly of two substrate-supported thin-film superconductors connectorized by a hydroxide-catalyzed bond.

FIG. 2A illustrates a cryogenic conductance probe measuring a superconductive contact similar to one shown in FIG. 1A.

FIG. 2B is a side view of the cryogenic conductance probe of FIG. 2A.

### DESCRIPTION OF THE PREFERRED EMBODIMENT(S)

Bonding techniques disclosed in the above-referenced U.S. Pat. No. 6,284,085, entitled “ULTRA PRECISION AND RELIABLE BONDING METHOD,” and its continuation-in-part, U.S. Pat. No. 6,548,176, entitled “HYDROXIDE-CATALYZED BONDING,” are hereinafter referred to as “HCB,” Hydroxide-Catalyzed Bonding. Similarly, surface modification techniques disclosed therein are hereinafter referred to as “HCSM,” hydroxide-catalyzed surface modification(s).

The HCB patent successfully demonstrated that the HCB process can bond a broad range of materials, including superconductors such as niobium (Nb) that have a sufficiently high density of surface hydroxyl groups. The HCB patent discloses that the HCB process may be utilized to bond superconductors in a hetero-configuration, i.e., a superconductor-insulator-superconductor layer exhibiting quantum-tunneling effects. The inventors of the present invention have discovered rather surprisingly that, when utilized to directly connectorize, interface, bond, contact, or otherwise adhere high- and/or low-T_{c} superconductors, the hydroxide-catalyzed bond further provides at least two outstanding advantages: superconductivity retention across the bonding interface and full mechanical fastening strength of the bonded superconductors.

Working examples of the present invention will now be described in details. Although the discussion hereinafter focuses on superconductive contact structures made of substrate-supported Nb thin-film superconductors and YBCO high-T_{c} superconductors, one skilled in the art would readily recognize that other implementations are also possible and may have various configurations, for example, a superconductive contact between superconductor thin films that are not substrate-supported; a superconductive contact between non-thin-film superconductors; and a superconductive contact between a non-thin-film superconductor and a superconductor thin film, which may or may not be substrate-supported.

According to an aspect of the present invention, a superconductor thin-film coating can be created on a supporting substrate, which may comprise one or more different materials physically combined together to support the superconductor thin film thereof. When two such substrate-supported thin-film coatings are placed face-to-face in tight physical contact, electric conductivity may be established across the resulting contact interface/junction. For example, such a contact mechanism may serve to connectorize two superconductor wires which are substrate-supported superconductor thin films, or are terminated by substrate-supported superconductor thin films, provided that the electrical resistance across the interface/junction is relatively low or literally zero when superconducting. The contacting/bonding mechanism may also be used to create certain electron quantum-tunneling effects, provided that the electrical resistance across the interface/junction may be rendered a certain resistance in a controlled manner.

A thin-film-to-thin-film contact can be achieved by mechanically fastening and/or bonding the two thin-film-supporting substrates with or without bonding the two superconductor thin films. Naturally, when the two thin films are bonded, it is optional to mechanically fasten and/or bond the two thin-film-supporting substrates. For better mechanical reliability, bonding is suggested; for reversibility in contacting, mechanical fastening is recommended. Prior to bonding/contacting, hydroxide-catalyzed surface modification(s) (HCSM) may be employed to help modifying the resistivity across the bonding/contacting interface to be formed. HCB may be used for bonding and, optionally, modifying the resistivity across the bonding interface as well. In terms of surface chemistry, HCB can be applied to all metallic materials (including low-T_{c} superconductors), all ceramic materials (including high-T_{c} superconductors), and certain insulators. For general information on materials that can be bonded utilizing HCB, readers are referred to U.S. Pat. No. 6,548,176. To enhance the effective resistivity and/or effective thickness of the bonding interface layer, chemical(s) and/or particulates may be added to the HCB bonding material according to HCB. For precision control of resistivity and/or spacing between the superconductors to be bonded/contacted, microscopic beads
a) of specific resistivity,
b) of relatively uniform distribution in size, and/or
c) of specific distribution density
   can be mixed in the bonding agent, as described in U.S. Pat. No. 6,548,176.

Prior to bonding/contacting, there are other optional techniques that may help to increase the resulting resistivity across the bonding/contacting interface in a controlled manner. For example, it can be achieved by using techniques well known in the art of microfabrication or conventional chemical surface treatments to deposit/coat/grow an electrically resistive layer on either one or both superconductor thin films to be bonded/contacted.

For metallic superconductor materials, e.g., many low-T_{c} superconductors, having a natural or an artificially grown surface oxide layer, the electric resistance across the interface/junction can also be minimized as follows:
a) Minimize or remove the surface oxide layers in a controlled manner by dry and/or wet etching techniques well known in the art of microfabrication and/or conventional chemical surface treatments to achieve a resulting electric conductivity higher than what would be without such treatment. Note both HCB and HCSM can help to generate on bare metal surfaces hydroxyl groups (—OH), which are essential to the HCB bonding mechanism. In other words, HCB can bond metallic superconductors regardless whether they are originally free of surface oxide(s).
b) Minimize or remove the surface oxide layers by scratching/polishing. For example, the scratching/polishing process can be conducted in an environment purged with any gas which does not re-oxidize or react in an unwanted manner with the metal surface(s) freshly created in the scratching/polishing process. Optionally, the scratching/polishing process can be conducted while contacting is maintained between the two to-be-bonded superconductors by their motions relative to each other. In other words, the two surface oxide layers on the two superconductor coatings may be forced to scratch/polish against each other, resulting in a thinner overall oxide layer sandwiched between the two superconductors.

When the two superconductors are of different materials, in principle, only the mechanically and/or chemically softer oxide layer may be reduced by the harder oxide layer first. However, if the adherence strength between the superconductor thin film and its substrate is relatively weak, the scratching/polishing process might inadvertently cause detachment of the thin film from its supporting substrate. Since the thin-film-against-thin-film process is a relatively simple but less controlled approach, monitoring the interface/junction resistance in real time may help to avoid over-thinning the oxide layer to be sandwiched by the two superconductors if a specific interface resistance or thickness of the oxide layer is intended.

In some embodiments, two superconductors can be bonded together using the following HCB process. For example, either as flats or substrate-supported thin films, the two superconductors can be
two metallic low-T_{c} superconductors, such as niobium (Nb),
two ceramic high-T_{c} superconductors, such as perovskite ceramics (e.g., YBa₂Cu₃O₇ or YBCO in general), or
a metallic low-T_{c} superconductor and a ceramic high-T_{c} superconductor.

Note HCB represents a class of bonding techniques in terms of bonding chemistry; it does not refer to a single specific recipe, as exemplified below.

1) Centrifuge aqueous solution of sodium silicate (or high-pH aqueous solution of highly hydrated silicon dioxide), e.g., water solution containing approximately 14% NaOH and approximately 27% SiO₂, at 4500 rpm for about five minutes. Note centrifugation can help creating relatively higher concentration of hydrated SiO₂ at the bottom of the centrifuge vial. Centrifugation might not be essential in bonding two surfaces with good surface figure match. When surface figure match is good, more diluted bonding solutions may be preferred if a thinner bond line or a lower interface resistivity is intended.

2) Pipette the solution by positioning the pipette tip at approximately 1/5 of the vial depth from bottom. The resulting bonding solution with higher concentration may improve bonding coverage, especially when bonding two surfaces with poor surface figure match.

3) Apply the bonding solution to one of the surfaces that are to be bonded together. Then close the interface gap and allow the capillary effect to help spreading the bonding solution in the interface. It has been found that surfaces with sub 200-micrometer features can be bonded. Surface figure mismatch can be as poor as approximately 0.5 millimeter or slightly worse. The bonding technique thus applies to precision to non-precision applications as well. For cases of poor surface figure match, weight or compression force can be applied to the interface to maximize bonding coverage. For more detailed discussion on the bonding solution/materials and applications thereof, readers are referred to the above-referenced U.S. Pat. Nos. 6,284,085 and 6,548,176.

The HCB bonding, HCSM surface modifications, and/or mechanical fastening approach disclosed herein make further modifications of the junction characteristics possible, and allows for further studying and employing the junction characteristics as a function of chemical and physical properties (e.g., compression strain) at the bonding/contacting interface. The bonding interface of the invention can be made in the millimeter range or it can be made extremely thin, i.e., less than about 10 nm in thickness, making it particularly useful for microfabrication. The techniques of the present invention provide unconventional alternatives to create junctions that may show electron quantum-tunneling effects.

To facilitate the fabrication of certain devices, the substrates supporting the superconductor thin films can be made more manageable in terms of dimension and configuration. For example, a superconducting quantum interference device, also named SQUID, can be fabricated relatively easily; the Josephson junction can be established using the aforementioned bonding/contacting approach without microfabrication involved. On the other hand, as one skilled in the art would appreciate, HCM and/or HCSM can be incorporated as a process in microfabrication.

Superconducting magnets further exemplify the advantages of the present invention. To generate strong magnetic fields, superconducting magnets rely on metallic low-T_{c} superconductor wires that carry high electric currents at a cryogenic temperature. On the other hand, ceramic high-T_{c} superconductor wires can serve, at a higher temperature, as high electric current leads characteristic of preferable high thermal resistance. Thus, superconducting magnets represent a type of applications where interfacing metallic low-T_{c} superconductor wires with ceramic high-T_{c} superconductor wires would be highly desirable.

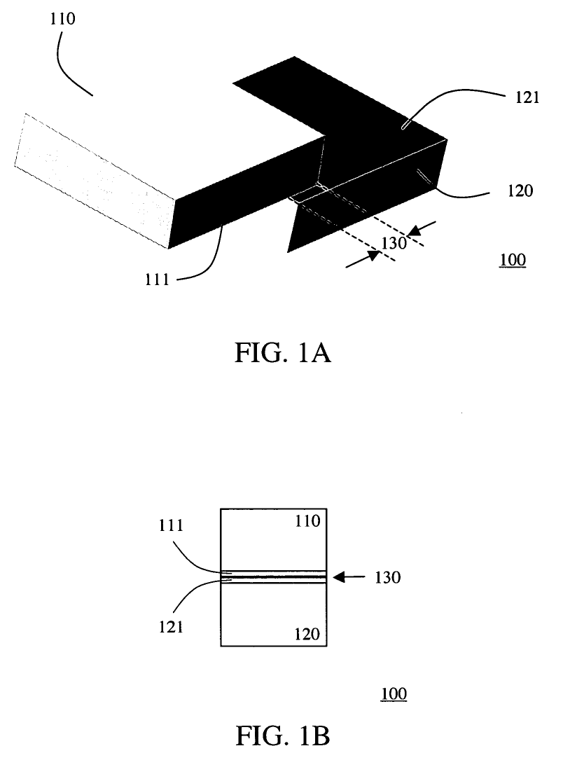

FIGS. 1A and 1B show, not to scale, an exemplary superconductive contact or contact structure 100 made mainly of two superconductor thin films 111 and 121, each of which is supported by a substrate 110 and 120, respectively. In this example, the thin-film samples 111 and 121 are 8000 Å thick Niobium (Nb), sputter coated on silica (quartz) substrates 110 and 120, each is approximately 6 mm×6 mm×1 mm. The thin-film samples 111 and 121 are arranged in a manner to allow the Nb films to face each other and partially overlap. A hydroxide-catalyzed silicate bond having an area 130 that is approximately 10 mm² is made utilizing the HCB process. One skilled in the art will appreciate that, although a silicate bond is formed in this example, the HCB process can be utilized to create other possible bonds. Naturally, the thickness of each superconductor is dependent upon the material used and application desired. The superconductors may be the same or different in thickness. In this example, the Nb thin-film samples are about 8000 Å in thickness. However, there are no upper limits. Other types of superconductors can be about 500 Å and up in thickness. Moreover, as one skilled in the art will understand, the patented HCB process represents a class of bonding techniques in terms of bonding chemistry; it does not refer to a single specific recipe. As such, the area 130 is not limited to the size disclosed here.

To verify that the hydroxide-catalyzed silicate bond between the two superconductors retains superconductivity across the bonding interface, four-lead conductance measurements were made on two such bonded contact structures chosen at random from a set of contacts similar to one shown in FIG. 1. The first set of measurements were made using four clip-type leads fed through a stainless tube and cooled by insertion into a liquid-helium storage dewar.

For the second set of measurements a special test probe was constructed which supports one substrate enabling secure lead connections to be made. The probe also incorporates a Germanium (Ge) resistance thermometer and has provision for temperature control. In both measurements the hydroxide-catalyzed silicate bond not only establishes electrical contact between the Nb films, it also provides the full mechanical fastening of the thin-film superconductors supported by silica substrates, i.e., the Nb films on quartz samples.

The conductance measurements below indicate that the contacts are conductive at room temperature and superconductive at liquid-helium temperature. At 4.2 Kelvin, critical currents were obtained as high as 50 mA, a level exceeding the requirements of many important applications.

Measurement Set 1

One bond/contact structure was chosen at random for a four-lead resistance measurement. The connections to the Nb were made using small female socket connectors that have been deformed in such a way as to provide a spring force in a pincer grasp between the back of the substrate surface and the Nb film. Four contacts are made, two to one piece and two to the other contacted piece. Current was supplied to two leads using a Constant Current Supply, BTI model CCS, available from Batterie Technologies Inc. of Ontario, Canada. Voltage across the remaining two leads was measured using a Digital MultiMeter, Kiethley model 196 DMM, available from Keithley Instruments, Inc. of Cleveland, Ohio, USA.

The room-temperature resistance measured 0.8 ohm. As a check the leads were rearranged in such a way as to measure the resistance of a single film and a very small resistance value was obtained (in the noise of the DMM) as expected.

The structure was then cooled down in a dip probe in a liquid-helium storage container. The resistance started to fall with temperature indicating metallic behavior and then went to 0 within the noise of the DMM.

With the structure at 4.2 K, measurements of the voltage as a function of drive current were made. The shorted voltage reading on the Kiethley 196 DMM was ˜0.009 mV. The current (I) supplied and voltage (V) measured across the hydroxide-catalyzed silicate bond are listed in Table 1 below.

TABLE 1

| I | V |
|---|---|
| 0.1 mA | 0.0090 mV |
| 0.2 mA | 0.0091 mV |
| 0.5 mA | 0.0090 mV |
| 1.0 mA | 0.0091 mV |
| 2.0 mA | 0.1970 mV |
| 5.0 mA | 1.4079 mV |
| 10.0 mA | 3.7918 mV |

The near-zero resistance measurement at low drive currents coupled with the abrupt rise of voltage drop as the current is increased above a critical value is a strong indication of superconductivity. Thus it appears that this structure has superconducting contact with a critical current of approximately 2 mA. Corresponding critical current density (J_{c}) and other additional parameters can be determined as they are known in the art.

The leads were rearranged as in the room-temperature case to measure the resistance across a single film. By this time, the shorted V drop had drifted to 0.008 V. Table 2 below lists the measurement results of current supplied across a single film at 4.2 K.

TABLE 2

| I | V |
|---|---|
| 0.5 mA | 0.0080 mV |
| 1.0 mA | 0.0080 mV |
| 2.0 mA | 0.0080 mV |
| 5.0 mA | 0.0081 mV |
| 10.0 mA | 0.0081 mV |
| 20.0 mA | 0.0080 mV |
| 50.0 mA | 0.0080 mV |
| 77.0 mA | 0.0080 mV |

The BTI CCS current supply topped out at 77 mA. This indicates that the structure has a single-film superconductive behavior with a critical current greater than 77 mA.

Measurement Set 2

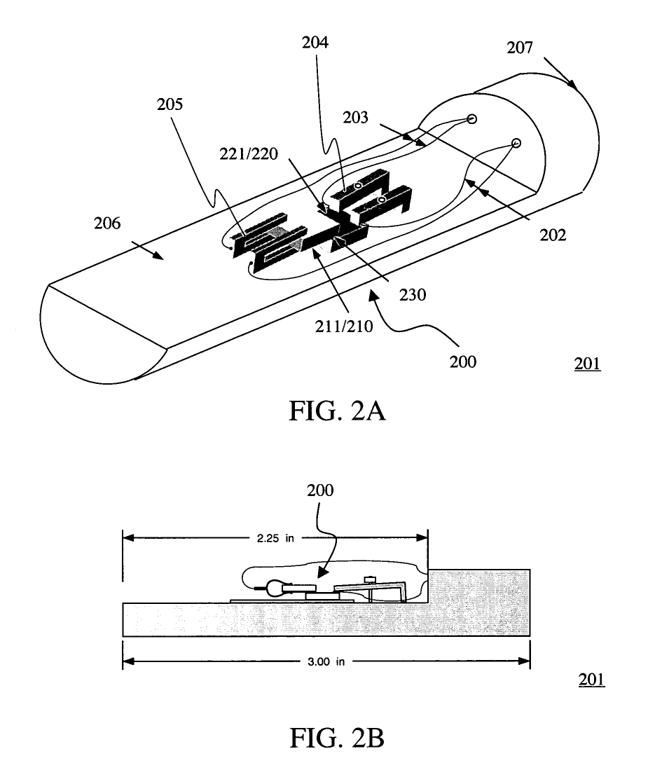

A second bond structure 200 was chosen at random for a four-lead resistance measurement. Similar to the structure 100, the structure 200 is composed of two superconductor Nb thin films 211 and 221 supported by silica (quartz) substrates 210 and 220, respectively. For this measurement, a special test probe 201, also called the cryogenic conductance probe as depicted in FIG. 2A, was designed to allow a more secure method to connect the current leads 202 and voltage leads 203. Lead connections on one section are made using L clamps 204 secured with 0-80 machine screws. This also brings this section into good thermal contact with the copper probe flat (cryogenic mount piece) 206. The other connections are made in a similar fashion as in the first measurement set, but with an improved clip design 205. The cryogenic conductance probe 201 is fitted to room temperature at one end 206 to receive a stainless steel probe tube. Holes drilled underneath the flat section support a Ge resistance thermometer (not shown) and a resistive heater (not shown). This will allow temperature control for future measurements. FIG. 2B is a side view of FIG. 2A.

Current was supplied to two leads using an HP model E3620A current source and the current was simultaneously measured using a Kiethley model 196 DMM. At 4.2 K, voltage across the remaining two leads was measured using an HP model 3440A DMM. Table 3 lists the results of current supplied and voltage measured across the hydroxide-catalyzed silicate bond where room-temperature resistance equals 0.7 Ohm. Shorted voltage measurement value is approximately 0.020 mV.

TABLE 3

| I | V |
|---|---|
| 0.00016 A | −0.025 mV |
| 0.00412 A | −0.025 mV |
| 0.02043 A | −0.025 mV |
| 0.03044 A | −0.025 mV |
| 0.04035 A | −0.026 mV |
| 0.05023 A | −0.026 mV |
| 0.05975 A | −3.760 mV |
| 0.08040 A | −5.950 mV |

This indicates that the structure has a single-film superconductive behavior with a critical current between 50 and 59 mA.

The leads were then rearranged to measure the resistance across a single film. The results of current supplied across a single film at 4.2 K are listed in Table 4 below.

TABLE 4

| I | V |
|---|---|
| 0.00015 A | 0.016 mV |
| 0.01134 A | 0.015 mV |
| 0.02037 A | 0.015 mV |
| 0.03393 A | 0.015 mV |
| 0.05281 A | 0.015 mV |
| 0.06172 A | 0.014 mV |
| 0.08124 A | 0.014 mV |
| 0.16604 A | 0.014 mV |
| 0.31824 A | 0.013 mV |
| 0.51305 A | 0.013 mV |
| 1.0042 A | 0.013 mV |

This indicates that the structure has a single-film superconductive behavior with a critical current greater than 1.0 A.

These measurements demonstrate that the hydroxide-catalyzed silicate bond of the structure provides robust mechanical and electrical contacts between thin-film Nb samples. The electrical connections are metallic in nature at room temperature and superconducting at liquid-helium temperature. Critical currents are sufficiently high to allow many useful applications, although the experiments described above did not establish limits on critical currents.

Below exemplifies another aspect of the invention, hydroxide-catalyzed silicate bonded high-T_{c} superconductors.

To measure resistance on bonded high-T_{c} superconductor samples, we purchased material samples from Edmund Scientific Co. of Tonawanda, N.Y., USA. These are YBCO (Yttrium-Barium-Copper-Oxide) high-T_{c} superconductor sintered samples 1.0 inch (25.4 millimeter) in diameter and 0.125 inch thick. The samples have a fairly rough surface and grainy structure with grains on the order or 0.001 inch or larger.

Using magnetization measurements and by 4-wire resistance measurements, the material samples were confirmed to superconducting at 77 K. The material samples exhibit metallic conduction at room temperature with characteristic resistance of about one ohm across the diameter of the material sample. The contact resistance is rather high so care must be taken to not heat the sample during the measurements. Low temperature measurements were performed with the sample submerged in liquid nitrogen inside an insulated cryo chamber.

The material samples were then cleaved into several pieces and hydroxide-catalyzed silicate bonding was performed using the aforementioned HCB process. A bonded high-T_{c} superconductor contact or contact structure (SAMPLE 1) was measured. The exemplary hydroxide-catalyzed silicate bond of the structure was determined to be mechanically robust, surviving force applications and repetitive thermal shocks from room temperature to 77 K.

Sample 1

Electrical measurements at room temperature show that the bonded interface conducts with same resistance as the bulk material sample, within the typical measurement error. After several thermal cycles between 77 K and room temperature, the sample is dried and heated with a heat gun to the order of 100° C. for approximately 1 hr. Electrical measurements are repeated.

Similar resistivity is measured at room temperature. At 77 K, the resistivity across the bond is zero to within measurement error up to an applied current of 11 mA and then increases approximately linearly with the applied current. As in the above examples, the leads were rearranged to measure the resistance across the bond (bonding interface). The current supplied and the corresponding voltage measurements are listed in Table 5 below.

TABLE 5

| I | V |
|---|---|
| 0.0001 A | 0.038 mV |
| 0.0014 A | 0.036 mV |
| 0.0031 A | 0.040 mV |
| 0.0039 A | 0.036 mV |
| 0.0054 A | 0.037 mV |
| 0.0079 A | 0.038 mV |
| 0.0098 A | 0.036 mV |
| 0.01104 A | 0.028 mV |
| 0.0218 A | −17.32 mV |
| 0.0313 A | −26.32 mV |
| 0.0582 A | −47.31 mV |

This indicates that the high-T_{c} superconductor contact structure has a superconductive behavior across the bond with a critical current greater than 11 mA.

TABLE 6
lists exemplary industrial applications of superconductivity.

| Devices/ | | Superconductor |
|---|---|---|
| Components | Application | Type |
| RF Filters | For cell phone communications | High-Tc |
| SQUIDs | Magnetic detection for nondestructive | Low-Tc and High- |
| | testing, medical imaging, defense | Tc |
| Magnets | MRI, | Mainly Low-Tc |
| | Laboratory Equipment | |
| Motors | Large Propulsion motor for ships | High-Tc |
| VARs | Voltage regulation for electric power | High-Tc |
| | industry | |
| SMES | Energy storage | Mainly Low-Tc, |
| | | some High-Tc |
| Cable | Power Transmission and | High-Tc |
| | Motors, Transformers | Low-Tc |
| Josephson | Voltage and resistance standards | Low-Tc |
| Junctions | | |

Although the present invention and its advantages have been described in detail, it should be understood that the present invention is not limited to or defined by what is shown or discussed herein. The tables, description and discussion herein illustrate technologies related to the invention, show examples of the invention and provide examples of using the invention. Known methods, procedures, systems, elements, or components may be discussed without giving details, so to avoid obscuring the principles of the invention. As one of ordinary skill in the art will appreciate, various changes, substitutions, and alterations could be made or otherwise implemented without departing from the principles of the present invention. Accordingly, the scope of the present invention should be determined by the following claims and their legal equivalents.

1. A superconductive contact structure comprising:
a first superconductor;
a second superconductor; and
a hydroxide-catalyzed bond connecterizing said first and second superconductors; wherein
said first and second superconductors are selected from a group consisting of high critical-temperature superconductors, low critical-temperature superconductors, and a combination thereof; wherein
said hydroxide-catalyzed bond retains superconductivity and provides full mechanical fastening strength between said first and second superconductors; and wherein
said superconductive contact structure exhibits a single-film superconductive behavior.

2. The superconductive contact structure of claim 1, wherein
said high critical-temperature superconductors are perovskite ceramics.

3. The superconductive contact structure of claim 1, wherein
said high critical-temperature superconductors are Yttrium-Barium-Copper-Oxide (YBCO) high critical-temperature superconductors.

4. The superconductive contact structure of claim 3, wherein
said YBCO high critical-temperature superconductors are about 0.125 inch thick and have a grainy structure with grains on the order or 0.001 inch or larger.

5. The superconductive contact structure of claim 1, wherein
said low critical-temperature superconductors are selected from a group consisting of metallic superconductors with a surface oxide layer, metallic superconductors without a surface oxide layer, and a combination thereof.

6. The superconductive contact structure of claim 1, wherein
said low critical-temperature superconductors are Niobium (Nb) superconductors selected from a group consisting of Nb thin-film superconductors, Nb non-thin-film superconductors, substrate-supported Nb thin-film superconductors, non-substrate-supported Nb thin-film superconductors, and a combination thereof.

7. The superconductive contact structure of claim 6, wherein
said Nb thin-film superconductors are about 8000 Å or more in thickness.

8. The superconductive contact structure of claim 1, wherein
said first and said second superconductors are about 500 Å or more in thickness.

9. The superconductive contact structure of claim 8, wherein
said first and said second superconductors have same or different thickness.

10. The superconductive contact structure of claim 1, wherein
said hydroxide-catalyzed bond is about 1.0 mm in thickness.

11. The superconductive contact structure of claim 1, wherein
said hydroxide-catalyzed bond is less than 10 nm in thickness.

12. The superconductive contact structure of claim 1, wherein
said superconductive contact structure is conductive at room-temperature and superconductive at liquid-helium temperature.

13. The superconductive contact structure of claim 1, wherein
said superconductive contact structure has a resistance of zero or substantially near zero at liquid-helium temperature.

14. The superconductive contact structure of claim 1, wherein
said superconductive contact structure has superconductivity at 4.2 K.

15. The superconductive contact structure of claim 1, wherein
said superconductive contact structure has superconductivity at 77 K.
